(19) United States
(12) Patent Application Publication
(10) Pub. No.: US 2011/0168274 A1
(43) Pub. Date: Jul. 14, 2011

(54) Method For Producing A Multi-Chamber Tank

(75) Inventors: Paul Fletcher, Schwarzach (AT); Otto Feldner, Saalfelden (AT); Gregor Wasle, Reutte (AT)

(73) Assignee: Alutech Gesellschaft M.B.H., Lend (AT)

(21) Appl. No.: 13/061,288

(22) PCT Filed: Aug. 3, 2009
(86) PCT No.: PCT/AT2009/000295

§ 371 Date: Feb. 28, 2011

(30) Foreign Application Priority Data
Sep. 3, 2008 (AT) GM 474/2008

(51) Int. Cl. B23P 11/00

(52) U.S. Cl. 137/15.01

(57) ABSTRACT

The invention relates to a method for producing a multi-chamber tank for fuels of motor vehicles, said tank comprising at least one internally coated first and at least one internally coated second chamber. The method comprises the following steps: making a first metal tank segment available, said segment containing the first chamber and an externally protruding peripheral collar, rotolining the first tank segment (4) to internally coat the first chamber with a plastic material, and connecting a second metal tank segment to the peripheral collar to form the second chamber between the second tank segment, the peripheral collar and the exterior of the second tank segment, the first tank segment being retained by its peripheral collar during rotolining.

The present invention relates to a method for producing a multi-chamber tank for motor vehicle operating media, said tank having at least one internally-coated first chamber and at least one internal-coating-free second chamber, and said method comprising the following steps: providing a first metal tank segment, which segment contains the first chamber and comprises an externally protruding peripheral collar, rotolining the first tank segment in order to internally coat the first chamber with plastics material, and connecting a second metal tank segment to the peripheral collar to form the second chamber between the second tank segment, the peripheral collar and the outer face of the first tank segment.

Metal tanks coated internally with plastics material are required in particular for aggressive motor vehicle operating media, for example urea solutions such as AdBlue®, which are used as catalyst liquids for cleaning the exhaust gas of diesel engines. The plastics material coating is generally formed by rotolining in the interior of the tank (in situ). Plastics material granulate is introduced into the tank through an opening, the opening is sealed and the tank is rotated with heating until the plastics material melts uniformly on the inner face of the metal wall where it forms a plastics material coating. The opening is then uncovered again.

Multi-chamber tanks with separate chambers for different operating media, for example fuel on the one hand and catalyst liquid on the other, are known from EP 1 350 654 A1.

WO 2007/080078 describes a method of the type mentioned at the outset for producing a multi-chamber tank comprising an internally-coated chamber for catalyst liquid and an internal-coating-free chamber for fuel. The tank is segmented and only the tank segment containing the chamber to be coated is mounted in the rotolining machine for optimal utilisation of space. The first tank segment comprising the internally-coated chamber is then removed and welded flushly on a peripheral collar to the second tank segment.

In the method of WO 2007/080078 the first tank segment is retained in the rotolining machine by retention straps. The retention straps extending over the outer surface of the first tank segment may produce scratch marks or pressure marks which significantly impair the surface quality of the end product. Furthermore, the retention straps interfere with the transfer of heat in the rotolining machine, which leads to a non-uniform distribution of heat over the inner face of the chamber and thus to non-uniform melting of the plastics material coating, and consequently to a non-uniform layer thickness of the plastics material coating.

The object of the invention is to overcome the described drawbacks of the prior art and to provide a method for producing a multi-chamber tank comprising at least one internally-coated chamber, which method ensures an excellent coating and surface quality of the end product.

This object is achieved by a method of the type mentioned at the outset which is characterised in accordance with the invention in that the first tank segment is retained via its peripheral collar during rotolining.

The region to be coated internally of the first tank segment thus remains free of thermal bridges or shadows during rotolining in such a way that the walls can be heated uniformly and uniform internal coating of the first chamber can thus be achieved.

In accordance with a particularly preferred embodiment of the invention, the first tank segment is retained during rotolining at a point on the peripheral collar which is covered by the second tank segment during the subsequent connection. Any scratching or denting of the outer face regions of the tank which are exposed after assembly is thus prevented, it thus being possible to obtain a flawless end product.

Said point is particularly preferably a welding fold of the peripheral collar, for example as is known per se from EP 1 350 654 A1, and ensures a flush outer surface of the end product once the segments have been assembled.

It is particularly advantageous if the welding fold is formed by the folded edge of a partition wall which terminates the first chamber toward the second chamber, thus enabling simple production with a minimal number of parts.

A further preferred embodiment of the invention is characterised by the further steps of applying a protective layer to the outer face of the first tank segment before rotolining and removing the protective layer after rotolining. The outer face can therefore be protected against any accidental contact during the rotolining process and a flawless end product can be obtained.

The first tank segment can preferably be additionally supported on its outer face during rotolining, particularly preferably at selected points or resiliently over a large area if relatively great forces are to be absorbed. The optional protective layer can also prevent any accidental contact with the outer surface; the pointwise support minimises the risk of any interference with the surface temperature distribution owing to its small contact surface.

The invention will be described in greater detail hereinafter with reference to an embodiment illustrated in the accompanying drawings, in which:

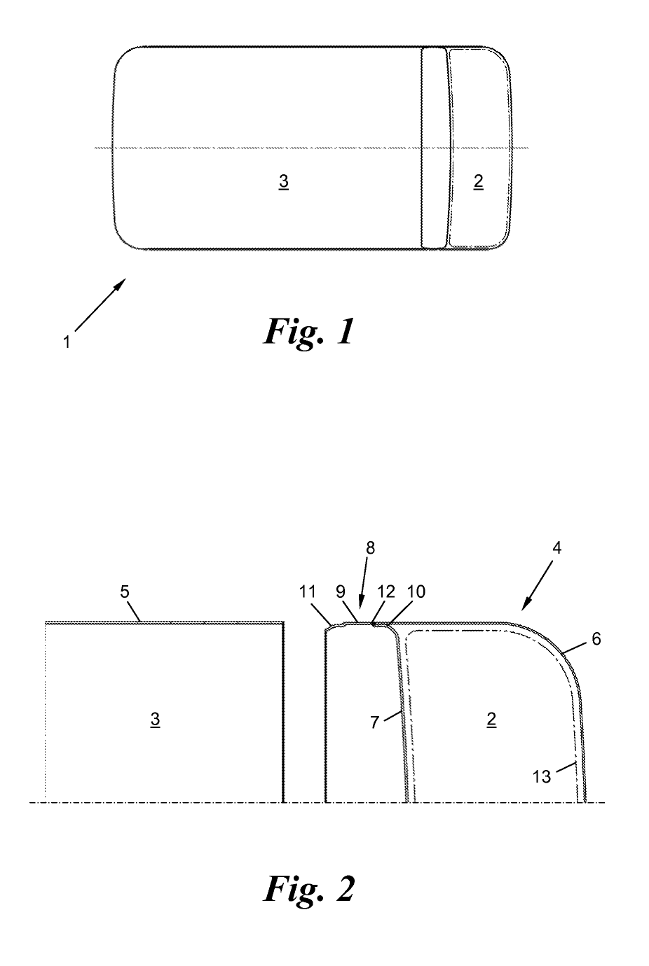

FIG. 1 shows a longitudinal section of a multi-chamber tank produced by the method of the invention;

FIG. 2 shows a detail in section of a first and second tank segment for producing the multi-chamber tank of FIG. 1;

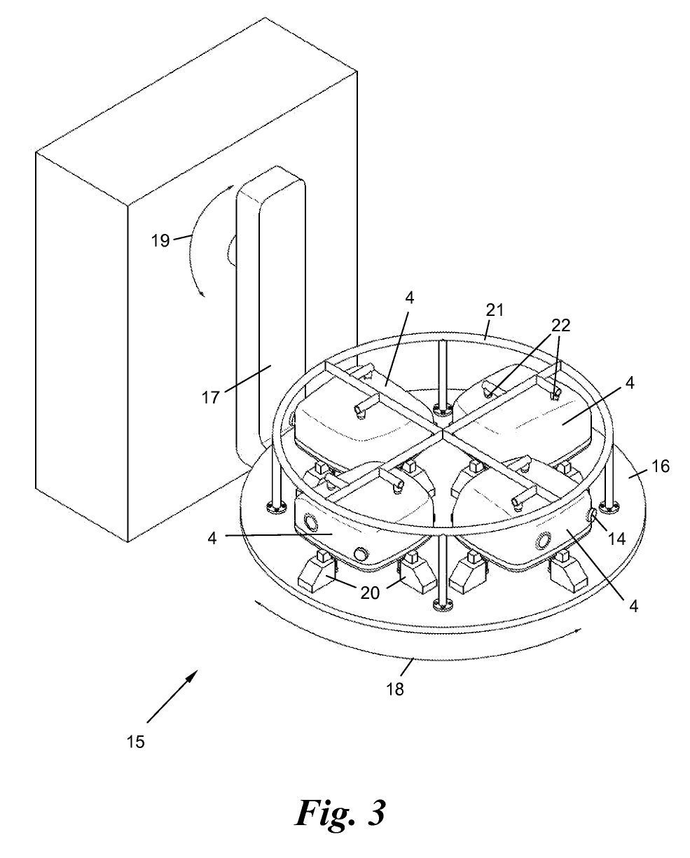

FIG. 3 is a schematic perspective view of a rotolining machine in order to illustrate the rotolining step of the invention;

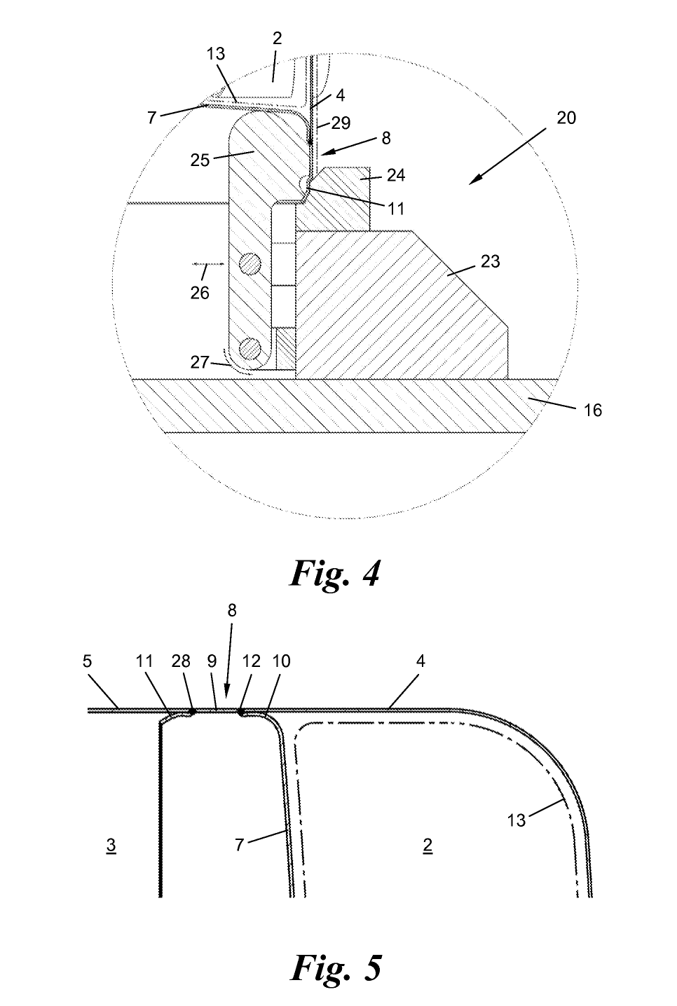

FIG. 4 shows a section through one of the clamping jaws of the rotolining machine of FIG. 3 in order to illustrate the mounting of the first tank segment during rotolining in accordance with the invention; and

FIG. 5 shows the step of connecting the tank segments after the rotolining step.

FIG. 1 shows a multi-chamber tank 1 comprising a first chamber 2 and a second chamber 3 is shown. The multi-chamber tank 1 can also contain more than two chambers 2, 3 and/or be equipped with internal fittings such as wash plates, sensors, take-off lines, filler necks, etc. (not shown), as is known to the person skilled in the art. The multi-chamber tank 1 is made of metal, preferably aluminium.

With reference to FIG. 2, the multi-chamber tank 1 is composed of a plurality of segments, more specifically in the example illustrated of a first tank segment 4 which contains the first chamber 2, and a second tank segment 5 which, together with the first tank segment, forms the second chamber 3. Both the first and second tank segments 4, 5 can be composed, in turn, of further segments and/or contain further chambers (not shown).

The first tank segment 4 is produced from a dome-shaped deep-drawn part 6 which is closed off by a partition wall 7 so as to form the first chamber 2. The partition wall 7 has a folded edge with a central swelling 9 and two welding folds 10, 11 arranged adjacently on either side. The peripheral edge of the deep-drawn part 6 overlaps the first welding fold 10 and is welded at 12 to the edge of the swelling 9 so as to be externally flush. Before the two tank segments 4, 5 are assembled, the folded edge of the partition wall 7 thus forms a peripheral collar 8 protruding outwardly from the first chamber 2 (to the left in FIG. 2) for connection to the second tank segment 5.

The second tank segment 5 is also a dome-shaped deep-drawn part and forms the second chamber 3 between it, the peripheral collar 8 and the outer face of the first tank segment 4 formed by the partition wall 7 after connection.

At least one of the chambers of the multi-chamber tank 1, in the example illustrated the chamber 2 of the first tank segment 4, is provided with an internal plastics material coating 13 by rotolining, whereas at least one of the further chambers, in this instance the chamber 3 of the second tank segment 5, remains free from coating.

As is known to the person skilled in the art, rotolining is a method which has been developed for lining hollow bodies with plastics material. The plastics material coating 13 is produced in situ by using the metal wall of the first chamber 2 as a mould. Plastics material, for example in granular form, is introduced into the chamber 2 of the tank segment 4 through an opening such as a filler neck 14 (FIG. 3), the opening is then sealed and the tank segment 4 is rotated polydirectionally with heating until the granulate melts on the inner face of the metal wall of the chamber 2 as a plastics material coating 13.

The plastics material coating 13 is preferably resistant to the operating medium to be received, in this instance urea solution. Plastics materials adapted for the plastics material coating include, for example, polyolefins such as HDPE (high density polyethylene), MDPE (medium density polyethylene), LDPE (low density polyethylene) or LLDPE (linear low density polyethylene).

FIG. 3 shows a rotolining machine 15 for carrying out the rotolining step. The rotolining machine 15 comprises a rotary table 16 which rotates at the end of an arm 17 in the direction of the arrow 18, whilst the arm 17 in turn rotates on a frame about an axis of rotation normal thereto in the direction of the arrow 19.

In the example illustrated four first tank segments 4 are retained on the rotary table 16, in each case by four clamping jaws 20, as will be described in greater detail with reference to FIG. 4; of course, other arrangement and numbers are also possible. An optional supporting frame 21 can additionally support the tank segments 4 on their upper faces by optional supports 22. For example, the supports 22 may be sharp needles which provide support at selected points, or alternatively soft resilient pads (not shown) provided over a large area.

By driving the rotary table 16 in the direction of the arrows 18 and 19, the tank segments 4 are tumbled, which leads to a uniform distribution of the plastics material granulate introduced therein over the entire inner face of the chambers 2. The metal walls of the tank segments 4 are heated using a heating device (not shown) in order to melt the plastics material granulate as a plastics material coating 13 on the inner faces of the chambers 2.

FIG. 4 shows in detail one of the clamping jaws 20 of the rotary table 16 and the step of retaining the tank segments 4 during rotolining. Each clamping jaw 20 comprises a rigid clamping shoe 23 which is fixed to the rotary table 16 and comprises a support 24 and a clamping lever 25 movable relative thereto. The clamping lever 25 is movable relative to the support 24 in the direction of the arrows 26, 27.

The peripheral collar 8 of the first tank segment 4 is mounted between the support 24 and the clamping lever 25, more specifically precisely in the region of every second welding fold 11 which is overlapped and covered by the second tank segment 5 once said second tank segment 5 has subsequently been connected. The mounting points of the first tank segment 4 are therefore no longer visible on the finished multi-chamber tank 1.

Furthermore, the mounting of the first tank segment 4 on its peripheral collar 8 protruding from the chamber 2 avoids any impairment of the heat distribution over the surface of the wall of the chamber 2, in such a way that the plastics material coating 13 melts on the inner face of the chamber 2 with a uniform wall thickness.

FIG. 5 shows the final step of connecting the second tank segment 5 to the first tank segment 4 after rotolining. The second tank segment 5 is slid onto the second welding fold 11 and is welded at 28 to the swelling 9 of the peripheral collar 8 of the first tank segment 4 so as to be externally flush.

Before the first tank segment 4 is mounted in the rotolining machine (FIG. 3), a protective layer 29 (FIG. 4) may be applied to the outer face of the first tank segment 4 in an optional step and removed after rotolining, or else even left on the end product. For example, the protective layer 29 may consist of silicone, Teflon, varnish or a commercially available surface treatment of the outer face of the first tank segment 4. If desired, the same type of protective layer 29 can also be applied to the outer face of the second tank segment 5.

The invention is not limited to the embodiments illustrated, but includes all variants and modifications which fall within the scope of the associated claims.

What is claimed is:

1. Method for producing a multi-chamber tank for motor vehicle operating media, said tank having at least one internally-coated first chamber and at least one internal-coating-free second chamber, and said method comprising the following steps:
providing a first metal tank segment, said segment containing the first chamber and an externally protruding peripheral collar, rotolining the first tank segment in order to internally coat the first chamber with plastics material, and
connecting a second metal tank segment to the peripheral collar to form the second chamber between the second tank segment, the peripheral collar and the outer face of the first tank segment, wherein the first tank segment is retained via its peripheral collar during rotolining.

2. Method according to claim 1, wherein the first tank segment is retained during rotolining at a point on the peripheral collar which is covered by the second tank segment during the subsequent connection.

3. Method according to claim 2, wherein said point is a welding fold of the peripheral collar.

4. Method according to claim 3, wherein the welding fold is formed by the folded edge of a partition wall which terminates the first chamber toward the second chamber.

5. Method according to claim 1, further comprising the steps of applying a protective layer to the outer face of the first tank segment before rotolining and removing the protective layer after rotolining.

6. Method according to claim 1, wherein the first tank segment is additionally supported on its outer face during rotolining, preferably at selected points or resiliently over a large area.
